(19) United States
(12) Patent Application Publication
(10) Pub. No.: US 2024/0271487 A1
(43) Pub. Date: Aug. 15, 2024

(54) RETRACTABLE STEP SYSTEM

(71) Applicant: Soudure Cote Et Fils Inc., Westbury (CA)

(72) Inventor: Yves Côté, Westbury (CA)

(73) Assignee: Soudure Cote Et Fils Inc., Westbury (CA)

(21) Appl. No.: 18/441,685

(22) Filed: Feb. 14, 2024

(30) Foreign Application Priority Data
Feb. 15, 2023 (CA) 3189962

(51) Int. Cl. E06C 1/12

(52) U.S. Cl. CPC E06C 1/12

(57) ABSTRACT

A retractable step system comprising a frame provided within a pit. A platform is connected to the frame with an opening proximate the end of the frame. Floating steps are mounted on the frame adjacent one another and aligned with the opening. A set of stairs is provided within the pit aligned with the opening. A lifting mechanism is configured to move the frame between an elevated configuration, where the platform is coplanar with the floor, and a lowered configuration, where the platform is lowered within the pit. The floating steps are adapted to be coplanar with the platform and the floor when the frame is in the elevated configuration, thereby defining a temporary floor covering the pit. The floating steps are adapted to be sequentially deposited on the set of stairs when moving the frame from the elevated configuration to the lowered configuration to provide access to the pit.

### TECHNICAL FIELD

The technical field generally relates to a retractable step system, and more particularly to a retractable step system permitting selective access between a floor level and another level.

### BACKGROUND

Vehicles need to be maintained throughout their life to correct faults or to carry out preventative maintenance. It is common for vehicles to be inspected at repair stations having pits, whereby a technician can position the vehicle over the pit and inspect, or carry out maintenance on, the bottom of the vehicle by entering the pit. These pits pose a safety problem, however, since users or items could fall into the pit when no vehicle is stationed overhead. Alternatively, it may be required for the users of the pit to repeatedly cover and uncover the pit, for example at the beginning and end of a shift, or multiple times throughout a shift. This is cumbersome and users may become less diligent over time, posing a hazard.

It would be particularly useful to be able to provide an improved device or assembly which would be able to overcome or at the very least minimize some of the known drawbacks and/or deficiencies associated with conventional methods and/or devices, for example.

### SUMMARY

According to an aspect, a retractable step system for use with a pit defined in a floor is provided. The retractable step system includes a frame provided within the pit; a platform connected to the frame and spaced apart from an end thereof to define an opening proximate the end of the frame; a plurality of floating steps mounted on the frame adjacent one another and aligned with the opening; a set of stairs comprising lateral frames, provided within the pit and aligned with the opening; and a lifting mechanism operably connected to the frame and configured to move the frame between an elevated configuration, where the platform is positioned to be coplanar with the floor, and a lowered configuration, where the platform is lowered within the pit; wherein the plurality of floating steps are adapted to be coplanar with the platform and the floor when the frame is in the elevated configuration, thereby defining a temporary floor covering the pit; and wherein the plurality of floating steps are adapted to be sequentially deposited on the lateral frames of the set of stairs when moving the frame from the elevated configuration to the lowered configuration to provide access to the pit.

According to an embodiment, the frame comprises frame indentations extending along opposite sides of the opening; and the floating steps each comprise a bottom surface complementarily shaped relative to the frame indentations and are configured to be received thereon to position the floating steps with respect to the frame.

According to an embodiment, the set of stairs comprises a pair of lateral frames comprising step indentations configured to receive the bottom surface of the floating steps as the frame is moved from the elevated configuration to the lowered configuration.

According to an embodiment, the set of stairs comprises a plurality of fixed steps extending between the pair of lateral frames.

According to an embodiment, the floating steps are removably mounted onto the frame, and wherein each floating step comprises a handle provided on a top surface thereof to facilitate removal.

According to an embodiment, the handle is recessed within the top surface.

According to an embodiment, the platform is spaced from a second end of the pit, thereby defining a second opening opposite the opening.

According to an embodiment, the retractable step system further includes a second set of stairs provided within the pit and aligned with the second opening, and wherein the plurality of floating steps comprise a first set of floating steps aligned with the opening, and a second set of floating steps aligned with the second opening.

According to an embodiment, the retractable step system further includes at least one vertically positioned guide rail extending along a vertical axis, wherein the platform has at least one guide lug configured to be received in the at least one vertically positioned rail to guide the frame along the vertical axis during movement of the platform.

According to an embodiment, the lifting mechanism comprises a scissor linkage.

The retractable step system of any one of claims 1 to 10, wherein the lifting mechanism is actuated using an electric system, a hydraulic system or a combination thereof.

According to an embodiment, the frame is provided in modular sections connectable to one another.

According to an embodiment, the floating steps have an L-shape.

According to an embodiment, the L-shape of the floating steps defines a riser and a tread of the corresponding step of the set of stairs.

According to another aspect, a repair station is provided. The repair station includes a recessed pit in the ground; and the retractable step system as defined above positioned inside the recessed pit to provide access between a floor level and the recessed pit.

According to an embodiment, the repair station comprises lighting on walls of the recessed pit.

According to an embodiment, the repair station comprises ventilation openings.

According to an embodiment, the recessed pit is shaped and sized to enable a vehicle to park over the recessed pit, and wherein the retractable step system enables access to an underside of the vehicle parked over the recessed pit.

According to another aspect, a pit access system for providing access to a pit is provided, the pit access system includes a fixed portion provided within the pit proximate an end thereof; a movable portion provided within the pit and operable between a first position and a second position; and a floating portion mounted to the movable portion and positioned above the fixed portion, the floating portion being displaceable with the movable portion; wherein, when the movable portion is in the first position, the movable portion and the floating portion are adapted to cooperate to define a temporary floor to cover the pit; and when the movable portion is in the second position, the floating portion and the fixed portion are adapted to cooperate to define a set of stairs descending into the pit.

According to another aspect, a pit access system for providing access to a pit is provided, the pit access system includes a fixed portion provided within the pit proximate an end thereof; a movable portion provided within the pit and operable between a first position and a second position; and a floating portion removably mounted to the movable portion and positioned above the fixed portion, the floating portion being displaceable with the movable portion; wherein the system is operable in a floor configuration, where the movable portion and the floating portion define a temporary floor to cover the pit; wherein the system is operable in an access configuration, where the movable portion defines a pit floor and the floating portion and fixed portion cooperate to define stairs enabling access to the pit floor; and wherein the system is operable in a maintenance configuration where, from the floor configuration, the floating portions are removed to enable access to the pit below the movable portion.

### BRIEF DESCRIPTION OF THE DRAWINGS

FIG. 1 is a perspective view of a retractable step system in an elevated configuration, in accordance with one embodiment.

FIG. 2 is a perspective view of a portion of the retractable step system shown in FIG. 1 in a lowered configuration, in accordance with one embodiment.

FIG. 3 is a perspective view of the retractable step system shown in FIG. 1, showing floating steps removed from the system and a lifting mechanism provided below a platform, in accordance with one embodiment.

FIG. 4 is a rear perspective view of a vehicle positioned relative to the retractable step system shown in FIG. 1, in accordance with one embodiment.

FIG. 5 is a cross-sectional view of the retractable step system shown in FIG. 4 in a semi-lowered configuration, in accordance with one embodiment.

FIG. 6 is a cross-sectional view of the retractable step system of FIG. 4, showing the system in the lowered configuration, in accordance with one embodiment.

FIG. 7 is a perspective view of the retractable step system shown in FIG. 5 and operated in the semi-lowered configuration to provide access to an undercarriage of the vehicle positioned thereon, in accordance with one embodiment.

FIG. 8 is a perspective view of the retractable step system of FIG. 1 with the floating steps removed, according to an embodiment.

### DETAILED DESCRIPTION

As will be explained below in relation to various implementations, the present disclosure describes a retractable step system. The retractable step system is selectively operable to allow access to a pit provided in a floor by defining a path between the floor and the pit. The system is further operable to cover the pit when access to the pit is not required. It is noted that the present system may be used to selectively allow access between two levels, and not necessarily a floor and a pit in the floor. More particularly, the retractable step system is provided with a platform, a plurality of floating steps mounted on the platform, a lifting mechanism, and a set of stairs mounted underneath the floating steps. The lifting mechanism moves the frame between an elevated configuration, where the platform is coplanar with the surrounding floor, and a lowered configuration, where the platform is lowered into the pit. The floating steps are coplanar with the surrounding floor in the elevated configuration, and sequentially deposited onto the set of stairs in the lowered configuration. A control system can be used to allow a user to selectively configure the retractable step system into different configurations.

In some embodiments, the lifting mechanism includes a scissor linkage assembly coupled to a hydraulic system operable to lift the platform mounted thereon. It is noted that the hydraulic system provides force multiplication, reducing the amount of power required to operate the platform. In other embodiments, the lifting mechanism can be purely mechanical, such as through a screw drive, or it may include a combination of mechanical and hydraulic lifting means. Other lifting mechanisms are also possible.

In some embodiments, the retractable step system is for use in a repair pit or maintenance station, such as for the repair and/or maintenance of vehicles. For example, it may be used in a garage, where the retractable step system allows selective covering and uncovering of the repair pit. It is noted that uncovering the repair pit allows access thereto for carrying out repairs on a vehicle parked over the repair pit, while covering the repair pit reduces the hazards related to having an open pit (e.g., prevents persons or items falling into the pit). However, it should be noted that the retractable step system may be used for other purposes. For example, it may be possible to use the retractable step system on a construction site, providing access between two different levels, such as the floor and a higher level or a recess in the ground. In such a case, the retractable step system may be a mobile system which can be transported and installed at different locations.

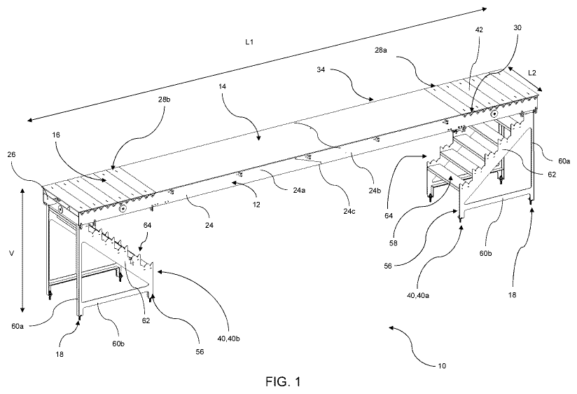

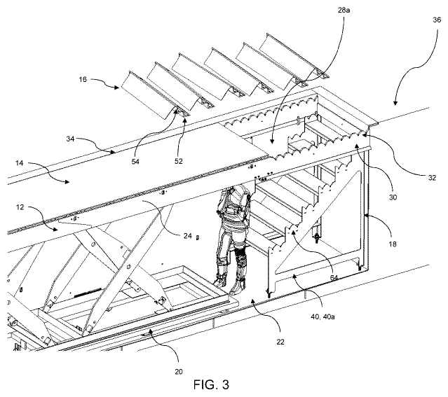

Referring to FIGS. 1 to 3, an embodiment of a retractable step system 10 for use with a pit 22 is shown. The retractable step system 10 includes a frame 12 displaceable relative to the pit 22, a platform 14 connected to the frame 12, floating steps 16 mounted on the frame 12 adjacent the platform 14, a stair assembly 18 provided within the pit 22, and a lifting mechanism 20 (see FIG. 3) provided inside the pit 22. The lifting mechanism 20 is operatively connected to the platform 14 and is operable to raise and lower the platform 14.

In this embodiment, the frame 12 defines a support structure for supporting various components of the retractable step system 10. The frame 12 is shaped and sized to support the platform 14 and the floating steps 16 thereon. The frame 12 comprises two longitudinal members 24 extending along a longitudinal axis L₁ and two lateral members 26 extending along a lateral axis L₂, each lateral member 26 connecting respective ends of the longitudinal members 24 to define a periphery of the retractable step system 10. In one embodiment, the longitudinal members 24 and/or the lateral members 26 may be provided in modular sections connectable to one another. For example, and with reference to FIG. 1, the longitudinal member 24 includes two modular sections 24a, 24b with a connecting portion 24c in the middle where the two modular sections 24a, 24b may be connected.

Alternatively, three or more modular sections may be provided to facilitate transport to an installation site. A plurality of shorter modular sections may also be easier to manipulate and handle than longer, bulkier and/or one-piece frame members, for example. The modular sections may be connectable through fastening means, such as by screws and/or bolts, or they may be connectable through mechanical locking, or any other suitable means. For example, mechanical locking may include two complementary hooks provided on respective modular sections and configured to engage the other one of the modular sections and/or the other hook for connecting the sections to one another. In one embodiment, the frame 12 may be made of metal, such as stainless or galvanized steel, but can alternatively be made of any other suitable material.

With the frame 12 defining the periphery of the retractable step system 10, the platform 14 is received on the frame 12 and connected thereto to define a floor, or at least a portion of a floor, of the retractable step system 10. The platform 14 may be connected to the frame 12 via fasteners or fixedly connected thereto by welding, for example. Similar to the frame 12, the platform 14 may also be built and assembled in modular sections (not shown in the figures) to facilitate transport to the installation site. In the illustrated embodiment, the platform 14 is spaced apart from the ends of the frame 12 to define two openings 28a, 28b on respective sides of the frame 12. Alternatively, the platform 14 may be spaced apart from just one of the ends of the frame to define a single opening 28a. In one embodiment, the platform 14 may be made of metal, such as stainless or galvanized steel, or any other suitable material.

In this embodiment, the frame 12 includes a holding portion 30 configured to define predetermined locations for receiving the floating steps 16. As such, the floating steps 16 can be positioned in respective locations along the holding portion 30, such as side-by-side/adjacent in a manner to at least partially cover the opening 28a. It is thus noted that the floating steps 16 can be positioned along the holding portion 30, and more specifically along the longitudinal axis L₁, in respective locations. In the illustrated embodiment, the holding portion 30 of the frame 12 includes slots, or indentations 32 positioned along the opening 28a, such as along the longitudinal members 24. The indentations 32 are positioned on both longitudinal members 24 of the frame 12 (e.g., opposite each other), although alternatively they may be positioned on just one of the longitudinal members 24. The indentations 32 are shaped and sized to enable cooperation with the floating steps 16.

Referring again to FIGS. 1 to 3, the floating steps 16 are adapted to engage the frame 12 along the holding portion 30. In this embodiment, the floating steps 16 include protrusions 52 shaped and sized to engage the indentations 32 of the holding portion 30 such that the floating steps 16 can be in predetermined locations. The protrusions 52 are illustratively provided along a bottom surface 54 of the floating steps 16 to facilitate engagement with the indentations 32. In addition, the protrusions 52 can be substantially elongated such that a single protrusion 52 is adapted to engage a pair of indentations 32 (e.g., one indentation 32 on each longitudinal member 24 of the frame 12). The floating steps 16 can therefore be “slotted” onto the frame 12, and are held in place via the cooperation between the indentations 32 and the protrusions 52. It is noted that the floating steps 16 are mounted on the frame 12 without the use of fasteners, where the complementary shape between the indentations 32 and the protrusions 52 is configured to retain each floating step 16 in a desired location and position.

In the illustrated embodiment, each floating step 16 includes a pair of protrusions 52 and is thus configured to engage four (4) indentations 32 of the holding portion 30, that is to say, two pairs of indentations 32 positioned opposite each other on each longitudinal member 24. It is appreciated that providing a pair of protrusions 52 defining four (4) contact points with the frame 12 can assist in increasing a stability of the floating steps 16 on the frame 12. In the illustrated embodiment, each protrusion 52 is a singular elongated protrusion extending across the floating steps 16. However, it is noted that other configurations are possible, such as having a pair of protrusions spaced along opposite ends of the bottom surface 54 of each floating step 16 (instead of a singular elongated protrusion 52), for example. It should be noted that, although the indentations 32 and the protrusions 52 are illustrated as being substantially triangular, they may be in other shapes (e.g., rectangular). Moreover, it is appreciated that, in some embodiments, the frame 12 can be provided with protrusions while the floating steps 16 are provided with indentations. As will be described further below, the floating steps 16 can be mounted on the frame 12 adjacent one another to generally cover the openings 28a, 28b, and are adapted to cooperate with the platform 14 to define a temporary floor 34 configured to cover the pit 22 (seen in FIG. 1). Upon operation of the retractable step system 10, the floating steps 16 are adapted to disengage the frame 12, and engage a stair assembly 18 provided within the pit 22 to define a path providing access to the pit 22 (e.g., from the surrounding floor 36).

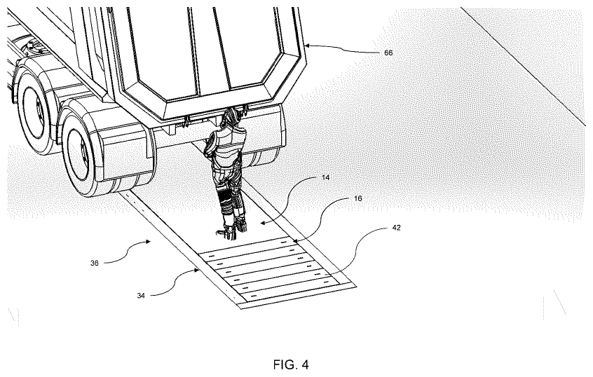

Now referring to FIGS. 3 to 6, a lifting mechanism 20 is operatively connected to the frame 12 and is adapted to selectively retract (e.g., lower) or extend (e.g., lift) to displace the frame 12. More specifically, in this embodiment, the lifting mechanism 20 is connected to the longitudinal members 24 of the frame 12. The lifting mechanism 20 is operable to move the frame 12 between an elevated configuration, where the frame 12 is positioned to have the platform 14 be coplanar with the surrounding floor 36 to define the temporary floor 34, and a lowered configuration, where the frame 12 and the platform 14 are lowered within the pit 22. In the illustrated embodiment, the lifting mechanism 20 includes a scissor linkage assembly or “scissor lift” provided beneath the platform 14. Any suitable type and/or combination of scissor lifts can be used. It is appreciated that scissor lifts are well known in the art and its structure will therefore not be described further.

In accordance with one embodiment, the lifting mechanism 20 may be connected to a source of motive force (not shown) for raising and lowering the frame 12 and platform 14. In one example, the source of motive force may include an electric motor, a hydraulic motor or a combination thereof. The source of motive force may be connected to a control system allowing control of the lifting mechanism 20. For example, in the case of an electric motor, the electric motor may be connected via wired or wireless means to an electrical control panel (not shown) provided at or above floor level. The control panel allows a user to operate and position the platform 14 in a desired configuration. In some embodiments, the lifting mechanism 20 can include a locking mechanism configured to selectively disengage the source of motive force from the lifting mechanism 20, thereby preventing movement of the lifting mechanism 20. The platform 14 and the floating steps 16 may therefore be “locked” or secured in position. The lifting mechanism 20 may additionally include a hydraulic lifting system to facilitate actuation thereof. Alternatively, the lifting mechanism 20 may include any other suitable mechanism for lifting the platform 14, such as one or more hydraulic cylinders adapted to lift or retract the platform 14, a screw drive system, where a screw converts rotary motion (e.g., of an electric motor) to linear motion, or any other suitable lifting mechanisms or combination thereof.

In some embodiments, in order to facilitate movement of the frame 12 and the platform 14 between the elevated and lowered configurations, one or multiple guide rails (not shown) may be positioned within the pit 22 to guide the platform 14 (e.g., along a vertical axis V). The platform 14 can be adapted to engage the guide rails which can be configured to restrict the movement of the platform 14 to an axial movement (e.g., vertical up and down). The platform 14 may include one or multiple guide lugs adapted to engage and move along the guide rails to guide the frame 12 along a predetermined path. A safety mechanism may also be included so that the system is automatically stopped if it encounters resistance in the pit 22 (e.g., due to the presence of an object or person in the pit 22).

Referring again to FIGS. 1 to 3, the retractable step system 10 includes a stair assembly 18 positioned within the pit 22. The stair assembly 18 can include a set of stairs 40 positioned adjacent an end of the pit 22 in order to be aligned with the opening(s) defined by the frame 12. Therefore, upon lowering the frame 12 and the platform 14 within the pit 22, the set of stairs 40 can extend through the opening(s) without interfering with the movement of the frame 12 and/or the platform 14. In this embodiment, the stair assembly 18 includes a first and a second set of stairs 40a, 40b, provided at opposite ends of the pit 22 and aligned with respective openings 28a, 28b of the frame 12. Each set of stairs 40a, 40b comprises a pair of lateral frames 56 and a plurality of fixed steps 58 fixedly mounted between the lateral frames 56. In the illustrated embodiment, the lateral frames 56 have a substantially triangular profile each comprising two orthogonal members 60a, 60b and a diagonal member 62. The fixed steps 58 are adapted to provide a gradual descent into the floor of the pit 22 along the diagonal member 62.

In the illustrated embodiment, the diagonal member 62 of each lateral frame 56 includes step indentations 64 complementarily shaped relative to the protrusions 52 of the floating steps 16. The floating steps 16 are therefore adapted to cooperate with the sets of stairs 40a, 40b in order to be mounted onto the respective lateral frame 56 in respective locations and positions. Similar to the indentations 32 of the frame 12, cooperation between the protrusions 52 and the step indentations 64 can prevent longitudinal movement of each floating step 16. In the illustrated embodiment, each one of the lateral frames 56 is secured in place with respect to the floor of the pit 22, such as by mounting bolts, for example. Alternatively, any other form of fastening may be used.

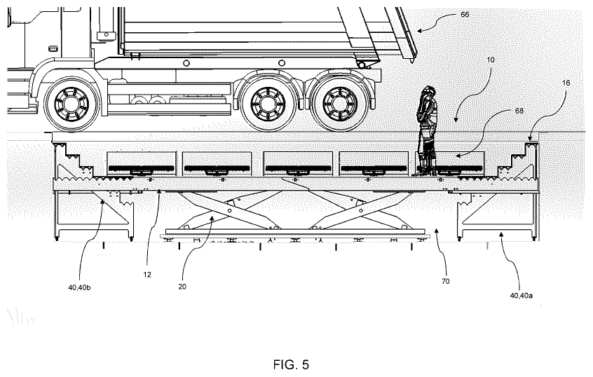

With reference to FIG. 1, when in the elevated configuration, each set of stairs 40a, 40b is positioned below respective openings 28a, 28b, and therefore below the floating steps 16 covering the openings. It is noted that the floating steps 16 are supported and held in place by the indentations 32 of the frame 12. While in the elevated configuration, the floating steps 16 are adapted to cooperate with the platform 14 to define the temporary floor 34 for covering the pit 22. As such, while the temporary floor 34 is in position, the floating steps 16 cover the openings 28a, 28b via their engagement with the holding portion 30, and the sets of stairs 40a, 40b are hidden from view within the pit 22. With reference to FIGS. 5 to 7, as the frame 12 is moved to the lower configuration, the floating steps 16 are sequentially deposited onto the sets of stairs 40a, 40b (e.g., on respective step indentations 64 of the lateral frames 56). More particularly, the protrusions 52 of each floating step 16 engage with respective step indentations 64, such that, in the lowered configuration, the floating steps 16 are supported by the lateral frames 56. It should be noted that, in the lowered configuration, the platform 14 can define a floor of the system 10 between the sets of stairs 40a, 40b. The floating steps 16 are thus held in place on the lateral frames 56 which have extended through the openings 28a, 28b as the frame 12 was lowered into the pit 22. As such, the floating steps 16 and the sets of stairs 40a, 40b are adapted to cooperate to define an access path which provides access to the floor of the pit 22.

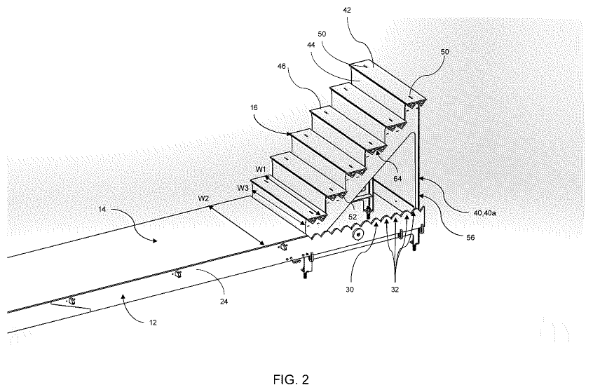

In this embodiment, each floating step 16 includes a top surface 42 and a lateral surface 44 connected to and extending from one another to define a generally L-shape. As seen in FIG. 1, when in the elevated configuration, each floating step 16 is positioned to have their top surface 42 be coplanar with the platform 14 to define the temporary floor 34, while the lateral surfaces 44 extend into the pit 22 (e.g., below the temporary floor 34), out of sight. In other words, in this embodiment, the top surfaces 42 are parallel to the platform 14 and therefore extend along the longitudinal and lateral axes L₁, L₂. Now referring to FIG. 2, when in the lowered configuration, each floating step 16 engages respective step indentations 64 to define a staircase between the surrounding floor 36 and the pit 22. As such, it is noted that the top surfaces 42 can define treads of the steps of the staircase, and that the lateral surfaces 44 can define risers of the steps. It is appreciated that other configurations are possible, such as having floating steps 16 having only a top surface (i.e., without a lateral surface). In some embodiments, the top surfaces 42 of the floating steps 16 have a width W₁ which is substantially similar to a width W₂ of the frame 12 (e.g., to enable covering the openings 28a, 28b), and the lateral surfaces 44 have a width W₃ that can be slightly smaller than the width W₁ of the top surface 42 to avoid interference with the frame 12 during movement.

Each floating step 16 is removably mounted on the frame 12 and the stair assembly 18 to enable engagement and disengagement with these structures during operation of the step system 10 (e.g., during movement of the frame 12). It should thus be understood that, whether in the elevated configuration or the lowered configuration, the floating steps 16 can be removed from the system 10, for instance, manually, by lifting the steps 16 from the corresponding indentations 32, 64. In this embodiment, each floating step 16 can be provided with a handle 50 configured to facilitate manipulation of the floating step 16, for installation in the retractable step system 10 and/or removal therefrom. As seen in FIG. 2, each floating step 16 can be provided with a pair of handles 50 spaced from one another on the top surface 42. In some embodiments, the handles 50 can be recessed within the top surface 42 to allow for a substantially flat top surface 42, although other configurations are possible.

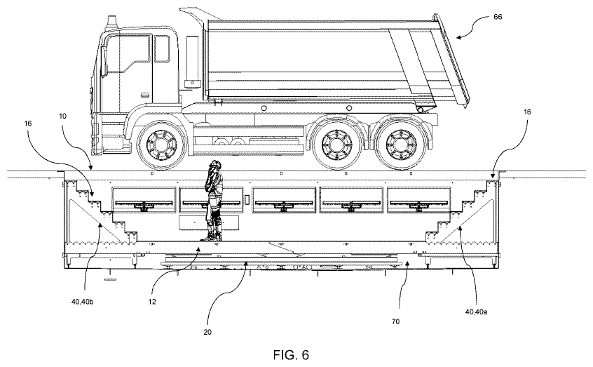

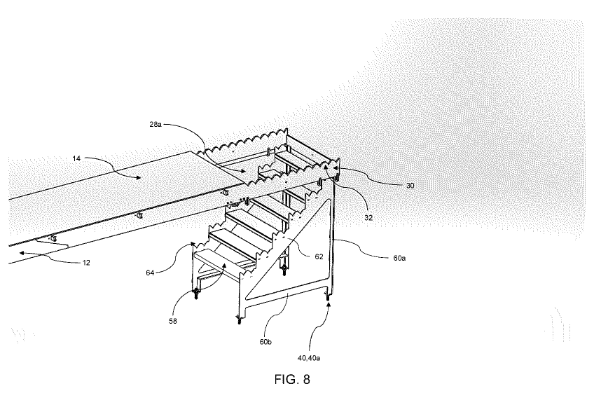

It is further noted that removing the floating steps 16 while the system is in the elevated configuration can enable access to the pit 22 below the platform 14. As such, maintenance can be provided to the platform 14, the lifting mechanism 20, etc. In the illustrated embodiment, the fixed steps 58 of the stair assembly 18 are provided between the lateral frames 56 to defines steps and provide a means for accessing the floor of the pit 22 when the floating steps 16 are removed from the frame 12 (see FIG. 8). Alternatively, the fixed steps 58 may be absent between the lateral frames 56 so that the floating steps 16 are required to access the floor of the pit 22. Referring again to FIGS. 5 to 7, the retractable step system 10 is installed as part of a repair station 70 adapted to repair vehicles, for example. In some embodiments, a vehicle 66 can be positioned (e.g., driven and parked) over the pit 22 (FIG. 6) and inspected from the floor level as the platform 14 and the floating steps 16 define the temporary floor 34 covering the pit 22.

Upon operation of the step system 10 to lower the platform 14 into the pit 22, an underside of the vehicle 66 can be inspected, for example, for maintenance and repairs. The pit 22 may be shaped and sized to be suitable for a variety of vehicles, including passenger cars and trucks. In the illustrated embodiment, the pit 22 has a substantially rectangular shape. Alternatively, it is appreciated that other shapes are possible, such as oval or circular. In some embodiments, the repair station 70 can include elements configured to facilitate the use of the repair station 70. For example, lighting 68 may be provided on the walls of the pit to illuminate the pit 22 and the underside of the vehicle 66 when repairs and maintenance are being carried out. In addition, drain openings (not shown) may also be provided in the pit 22 to allow fluids (e.g., water, oils and other substances) to be drained from inside the pit 22. This can enable cleaning the vehicles with water or other liquids. Additionally, ventilation openings (not shown) may be provided within the pit 22, such as along the walls, to provide adequate airflow. In one embodiment, conditioned air (e.g., cooled or heated) may be provided through the ventilation openings.

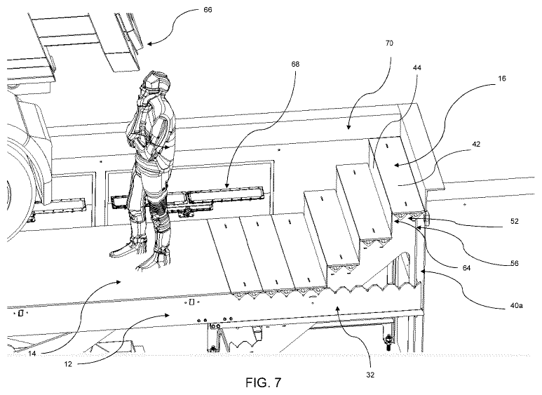

The system described herein may similarly be referred to as a pit access system for providing access to the pit 22. The pit access system comprises a moveable portion, a floating portion and a fixed portion. The movable portion may correspond to the platform 14, which may be selectively positioned between a first position and a second position, corresponding to the elevated and the lowered configurations. Alternatively, the movable portion may be configured into three or more positions, including for example, a semi-lowered position (seen in FIGS. 5 and 7) between the elevated and the lowered configurations. The floating portion may correspond to the floating steps 16. The pit access system can be operated in a floor configuration, where the movable and floating portions cooperate to define a temporary floor covering the pit. The pit access system can be further operated in an access configuration, where access is provided into the pit by moving the movable portion into the second position. The pit access system can additionally be operated in a maintenance configuration, whereby, when the movable portion forms a portion of the temporary floor, the floating portions are removed to enable access to the pit below the movable portion. More particularly, removal of the floating portion allows descent into the pit through the fixed portion to access the underside of the movable portion.

It is thus noted that the fixed portion may correspond to the stair assembly 18 positioned inside the pit 22. When the movable portion is in the first position, corresponding to the elevated configuration and aligned with the surrounding floor, the floating portion is also aligned with the surrounding floor and the fixed portion is hidden from view. When the movable portion is in the second position, corresponding to the lowered configuration, the pit becomes accessible. In the second position, the floating portion is received on the fixed portion to define a set of stairs descending into the pit to provide access thereto.

The present disclosure may be embodied in other specific forms without departing from the subject matter of the claims. The described example embodiments are to be considered in all respects as being only illustrative and not restrictive.

In the present disclosure, an embodiment is an example or implementation of the fondue assembly. Appearances of “one embodiment,” “an embodiment” or “some embodiments” do not necessarily all refer to the same embodiments. Although various features may be described in the context of a single embodiment, the features may also be provided separately or in any suitable combination. Reference in the specification to “some embodiments”, “an embodiment”, “one embodiment”, or “alternative embodiments”, means that a particular feature, structure, or characteristic described in connection with the embodiments is included in at least some embodiments, but not necessarily in all embodiments.

Positional descriptions such as “radial”, “inward”, “outward”, “top”, “bottom”, “peripheral”, “internal”, “external”, and the like should, unless otherwise indicated, be taken in the context of the figures and should not be considered limiting.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The implementations, geometrical configurations, materials mentioned and/or dimensions shown in the figures are optional, and are given for exemplification purposes only.

In addition, although the optional configurations as illustrated in the accompanying drawings comprise various components and although the optional configurations of the retractable step system as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the implementation and use of the retractable step system, and corresponding parts, as briefly explained and as can be easily inferred herefrom, without departing from the scope of the disclosure.

1. A retractable step system for use with a pit defined in a floor, the retractable step system comprising:
a frame provided within the pit;
a platform connected to the frame and spaced apart from an end thereof to define an opening proximate the end of the frame;
a plurality of floating steps mounted on the frame adjacent one another and aligned with the opening;
a set of stairs comprising lateral frames, provided within the pit and aligned with the opening; and
a lifting mechanism operably connected to the frame and configured to move the frame between an elevated configuration, where the platform is positioned to be coplanar with the floor, and a lowered configuration, where the platform is lowered within the pit;
wherein the plurality of floating steps are adapted to be coplanar with the platform and the floor when the frame is in the elevated configuration, thereby defining a temporary floor covering the pit; and
wherein the plurality of floating steps are adapted to be sequentially deposited on the lateral frames of the set of stairs when moving the frame from the elevated configuration to the lowered configuration to provide access to the pit.

2. The retractable step system of claim 1, wherein:
the frame comprises frame indentations extending along opposite sides of the opening; and
the floating steps each comprise a bottom surface complementarily shaped relative to the frame indentations and are configured to be received thereon to position the floating steps with respect to the frame.

3. The retractable step system of claim 2, wherein the set of stairs comprises a pair of lateral frames comprising step indentations configured to receive the bottom surface of the floating steps as the frame is moved from the elevated configuration to the lowered configuration.

4. The retractable step system of claim 3, wherein the set of stairs comprises a plurality of fixed steps extending between the pair of lateral frames.

5. The retractable step system of claim 1, wherein the floating steps are removably mounted onto the frame, and wherein each floating step comprises a handle provided on a top surface thereof to facilitate removal.

6. The retractable step system of claim 5, wherein the handle is recessed within the top surface.

7. The retractable step system of claim 1, wherein the platform is spaced from a second end of the pit, thereby defining a second opening opposite the opening.

8. The retractable step system of claim 7, further comprising a second set of stairs provided within the pit and aligned with the second opening, and wherein the plurality of floating steps comprise a first set of floating steps aligned with the opening, and a second set of floating steps aligned with the second opening.

9. The retractable step system of claim 1, further comprising at least one vertically positioned guide rail extending along a vertical axis, wherein the platform has at least one guide lug configured to be received in the at least one vertically positioned rail to guide the frame along the vertical axis during movement of the platform.

10. The retractable step system of claim 1, wherein the lifting mechanism comprises a scissor linkage.

11. The retractable step system of claim 1, wherein the lifting mechanism is actuated using an electric system, a hydraulic system or a combination thereof.

12. The retractable step system of claim 1, wherein the frame is provided in modular sections connectable to one another.

13. The retractable step system of claim 1, wherein the floating steps have an L-shape.

14. The retractable step system of claim 13, wherein the L-shape of the floating steps defines a riser and a tread of the corresponding step of the set of stairs.

15. A repair station comprising:
a recessed pit in the ground; and
the retractable step system of claim 1 positioned inside the recessed pit to provide access between a floor level and the recessed pit.

16. The repair station of claim 15, wherein the repair station comprises lighting on walls of the recessed pit.

17. The repair station of claim 15, wherein the repair station comprises ventilation openings.

18. The repair station of claim 15, wherein the recessed pit is shaped and sized to enable a vehicle to park over the recessed pit, and wherein the retractable step system enables access to an underside of the vehicle parked over the recessed pit.

19. A pit access system for providing access to a pit, comprising:
a fixed portion provided within the pit proximate an end thereof;
a movable portion provided within the pit and operable between a first position and a second position; and
a floating portion mounted to the movable portion and positioned above the fixed portion, the floating portion being displaceable with the movable portion;
wherein, when the movable portion is in the first position, the movable portion and the floating portion are adapted to cooperate to define a temporary floor to cover the pit; and
when the movable portion is in the second position, the floating portion and the fixed portion are adapted to cooperate to define a set of stairs descending into the pit.

20. A pit access system for providing access to a pit, comprising:
a fixed portion provided within the pit proximate an end thereof;
a movable portion provided within the pit and operable between a first position and a second position; and
a floating portion removably mounted to the movable portion and positioned above the fixed portion, the floating portion being displaceable with the movable portion;
wherein the system is operable in a floor configuration, where the movable portion and the floating portion define a temporary floor to cover the pit;
wherein the system is operable in an access configuration, where the movable portion defines a pit floor and the floating portion and fixed portion cooperate to define stairs enabling access to the pit floor; and
wherein the system is operable in a maintenance configuration where, from the floor configuration, the floating portions are removed to enable access to the pit below the movable portion.
